(19) United States
(12) Patent Application Publication
(10) Pub. No.: US 2024/0302801 A1
(43) Pub. Date: Sep. 12, 2024

(54) AI PROCESS AND RECIPE OPTIMIZER

(71) Applicant: Seth Thompson, Ocean Grove, NJ (US)

(72) Inventor: Seth Thompson, Ocean Grove, NJ (US)

(21) Appl. No.: 18/493,771

(22) Filed: Oct. 24, 2023

(51) Int. Cl. G05B 6/02; G05B 13/02

(52) U.S. Cl. CPC G05B 6/02; G05B 13/0265

(57) ABSTRACT

The AI Process and Recipe Optimizer offers a novel approach in industrial and laboratory process management technology. This software tool is designed to interface directly with a Programmable Logic Controller (PLC) in real-time. As it collects and analyzes live data, it crafts and adjusts Process Recipes accordingly. Leveraging advanced algorithms, including regression, machine learning, and vector analysis, the tool constructs models for every variable in the recipe. If discrepancies arise between expected outcomes and actual results, the Recipe Maker can quickly correct these errors in real-time. It stands out by continuously refreshing these models with live data, ensuring they accurately reflect the most recent process trends and patterns. This unique integration of real-time data interfacing, immediate recipe formulation, and on-the-spot error correction sets a fresh benchmark in process management tools.

### FIELD

The present invention pertains to the realm of industrial and laboratory process management technology. It specifically focuses on the real-time monitoring, control, and optimization of these processes by leveraging advanced algorithms and data analytics.

### BACKGROUND

Historically, industrial and laboratory processes have relied on offline systems to generate and optimize process recipes and parameters. These traditional systems often function separately from real-time operations, leading to potential lags in data collection, processing, and subsequent adjustments. Over time, as industries have become more data-driven, there arose a need for tools that could directly interface with on-site control systems such as Programmable Logic Controllers (PLCs), to enable real-time data collection and instant recipe adjustments.

All current systems function offline or with significant delays in integrating live data. Furthermore, error corrections in these systems tend to be manual or require substantial reprocessing time, causing inefficiencies and potential losses.

There has been a discernible gap in the market for a tool that not only gathers and analyzes live data, but also formulates and adjusts process recipes on the fly, all while being able to self-correct in real time. Additionally, with the ever-evolving nature of processes, there is a need for a software tool that could continually update its models based on recent process trends and conditions.

Given the limitations of existing technologies, there was a clear demand for a more integrated solution that could offer:
1. Dynamic recipe formulation based on live and historical data.
2. Instant error detection and real-time corrections to align with intended outcomes.
3. Continuous model updates to stay up to date with the latest process trends and patterns.

The present invention was conceived to address these challenges, setting a new standard in the realm of process management tools.

### SUMMARY

AI Process and Recipe Optimizer offers a novel approach in industrial and laboratory process management technology. This software tool is designed to interface directly with a Programmable Logic Controller (PLC) in real-time. As it collects and analyzes live data, it crafts and adjusts Process Recipes accordingly. Leveraging advanced algorithms, including regression, machine learning, and vector analysis, the tool diligently constructs models for every variable in the process. If discrepancies arise between expected outcomes and actual results, the Recipe Maker can quickly rectify these errors in real-time. Furthermore, it stands out by continuously refreshing these models with live data, ensuring they accurately reflect the most recent process trends and patterns. This unique integration of real-time data interfacing, immediate recipe formulation, and on-the-spot error correction sets a fresh benchmark in process management tools. The sequence of operations for the program can be visualized in the flow diagram in FIG. 1.

### BRIEF DESCRIPTION OF THE DRAWINGS

FIG. 1: Flow Diagram of AI Process and Recipe Optimizer.

Table 1: Sample data table for import into the Recipe Maker.

FIG. 2: Model Report for the data and variables that the user imported.

FIG. 3: Recipe Maker interface.

FIG. 4: Diagram of carbonation process.

FIG. 5: Recipe example screenshot #1 demonstrating the “Variable to Calculate” feature.

FIG. 6: Recipe example screenshot #2 demonstrating the error calculation.

FIG. 7: Recipe example screenshot #3 demonstrating the error correction.

FIG. 8: Recipe example screenshot #4 demonstrating a process limitation.

FIG. 9: Recipe example screenshot #5 demonstrating changing the “Variable to Calculate”.

FIG. 10: Recipe example screenshot #6 demonstrating the programs versatility to achieve an outcome.

FIG. 11: Recipe example screenshot #7 demonstrating the first scenario where a user chooses a “Variable to Calculate”.

FIG. 12: Recipe example screenshot #8 demonstrating the second scenario where a user chooses a different “Variable to Calculate” but gets the same outcome for the dependent variable.

FIG. 13: Trending screens demonstrating live data being collected during a process run that can be imported into Recipe Maker to update the variables models.

FIG. 14: Trending screen with standard Feed Flow PID where a pump is controlling the soda at 4 different flowrates.

FIG. 15: Trending screen with “AI Enhanced” Feed Flow PID where a pump is controlling the soda at 4 different flowrates.

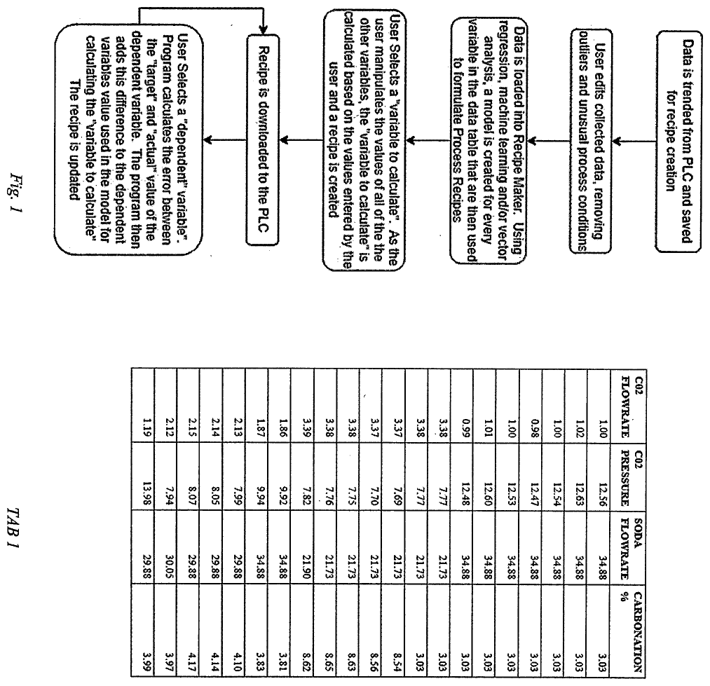

### DETAILED DESCRIPTION

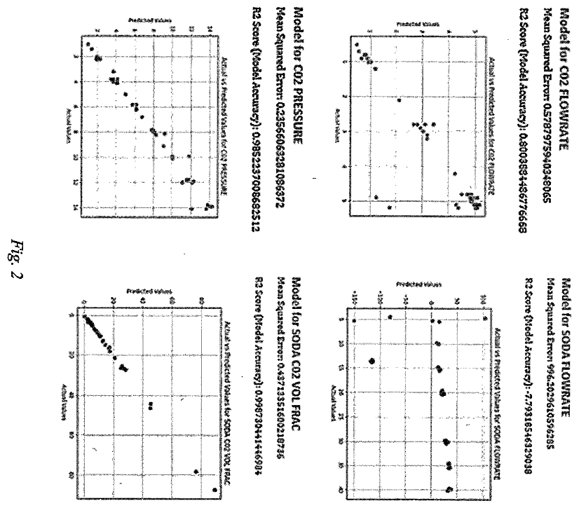

AI Process and Recipe Optimize is a tool designed for both industrial and laboratory settings. Its primary function is to aid in the efficient formulation of recipes based on a set of data. To initiate the program, process data, as in TAB 1, must first be loaded into the Recipe Maker. Once this data is loaded, the system employs techniques such as regression, machine learning, or vector analysis to form a model for every variable found in the data table. These models play a crucial role in formulating the Process Recipes for subsequent operations. As a part of its functionality, the Recipe Maker generates a report for each variable, as illustrated in FIG. 2. The reports evaluate the accuracy of each model and help determine whether an alternative method for creating the models should be used. After these preliminary steps, the Recipe Maker interface, depicted in FIG. 3, presents itself. The input fields, display fields, dropdown selection boxes, and buttons are described as follows:
Target Values: These represent the desired values the operator aims for the process to achieve.
Actual Values: These represent real-time readings from the PLC.
Variable to Calculate: This dropdown allows users to select which variable they wish to compute based on the input values of other variables.
Calculate: This button triggers the calculation or recalculation of the selected variable.
Download to PLC: This button facilitates the transfer of the formulated recipe (target values) to the PLC.
Dependent Variable: A selector that lets users choose the variable they aim to control and compute the error for.
Calculate Error: This button computes the difference between actual and setpoint alues for the dependent variable. Utilizing this discrepancy, a new value for the “Variable to Calculate” is determined.
Import Data: Allows users to input new, real-time data, thereby updating models for recipe recreation.
Save Recipe: Button to save the current recipe
Load Recipe: Button to load a previously saved recipe

In any given process, there are multiple variables that are interrelated and influence the outcome. The Recipe Maker software provides a feature where the operator can select a particular variable as the “Variable to Calculate”. By choosing this, the operator expresses the intent to compute the value of this variable's setpoint based on the current setpoints or values of other related variables. The software then uses its underlying models, derived from advanced algorithms, to predict the best value for this chosen variable to ensure the process achieves the desired outcome.

For example, if an operator has three variables: A, B, and C, and wishes to determine the value of A based on given setpoints for B and C, then A becomes the “Variable to Calculate”. Upon inputting the setpoints for B and C, the software utilizes its models to predict the most optimal setpoint for A.

The software has a feature that focuses on a “Dependent Variable”. This variable is the one that the operator wishes to control most accurately. The dependent variable's value depends on, or is influenced by, the values of other variables in the process.

The software constantly compares the real-time value of the dependent variable with its intended setpoint. If a discrepancy or error is noted between the real-time value and the setpoint, the software takes proactive corrective action. It revisits the original input value of the dependent variable used in the selected “variable to calculate” model, and adjusts it by adding the error to the original input value of the dependent variable. A new value for the selected “variable to calculate” is produced, and the recipe is updated.

To demonstrate more clearly how the Recipe Maker works, an example using the continuous carbonation of soda will be used. During carbonation, as soda moves along a production line, it encounters a carbonator, FIG. 4. There are four key variables in the carbonation process:
1. Soda Flowrate: Measured in liters per minute, it denotes the volume of soda flowing through the system.
2. CO2 Pressure: Expressed in PSI, this refers to the pressure of the carbon dioxide used for carbonation
3. CO2 Flowrate: This is the rate at which CO2 is introduced into the soda, and it's measured in liters per minute.
4. Carbonation %: Represented as a percentage, this value indicates the proportion of CO2 by volume present in the carbonated drink.

Typically during carbonation, when the Soda Flowrate increases but the CO2 Pressure and Flowrate stay the same, the Soda's Carbonation level decreases (more Soda volume for the same amount of C02 to carbonate). Conversely, increasing the C02 Pressure and Flowrate, with a static Soda Flowrate, will increase the CO2 Carbonation %.

After collecting data from a series of carbonation runs at different flowrates and pressures, the data can be imported into the recipe maker. Utilizing regression, machine learning and/or vector analysis, these relationships between the variables are established and can be used to create recipes.

In the first example, as shown in FIG. 5, the CO2 Flowrate has been chosen as the “Variable to Calculate”. The following values have been inputted for the other variables setpoints: CO2 Pressure: 10 PSI, Soda Flowrate: 35 LPM, Soda CO2 Vol Fraction: 3%. Using these values as the input for the C02 Flowrates model, the system calculates the CO2 Flowrate to be 1.4 LPM.

In this example the Carbonation % is identified as the Dependent Variable. During the recipe creation, the Soda Flowrate, CO2 Pressure, and C02 Flowrate are manipulated to achieve the desired Carbonation %.

Every so often, real-world situations or uncontrolled factors can lead to discrepancies between the setpoints predicted by the Recipe Maker and the actual recorded values. These differences are errors that the system must accommodate.

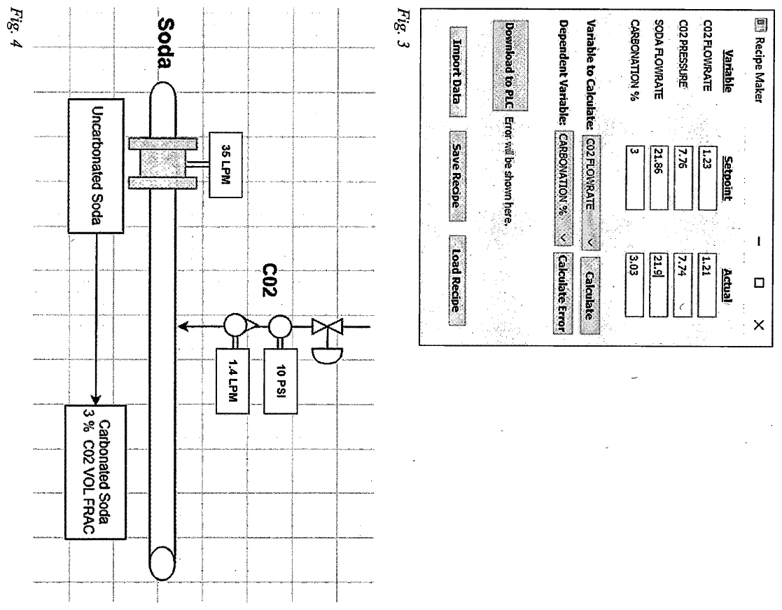

In the example shown in FIG. 6, the Recipe Maker observes a 0.3% error in Soda Carbonation. Instead of discarding this error, the system uses it as a corrective tool. The Recipe Maker's predictive model set the Soda Carbonation at 3%, but the actual reading is found to be 2.7%. This difference of 0.3% is our error.

To correct for this discrepancy, the system adds the error (0.3%) to the original Carbonation % input (3%). This gives an adjusted Soda Carbonation value of 3.3%.

Note: The setpoint (i.e., the target value) remains 3%. The adjusted value of 3.3% is merely a tool used by the model to accommodate for real-world discrepancies. This doesn't mean the system is aiming for a 3.3% carbonation; rather, it's a computational strategy to ensure the other variables (like CO2 flowrate) align properly to achieve the desired 3% in practice.

With the adjusted Soda Carbonation value, the system revisits the CO2 Flowrate calculation, keeping the other variables constant: CO2 Pressure: 10 PSI, Soda Flowrate: 35 LPM, Soda Carbonation: Adjusted to 3.3%. Using the C02 Flowrate model and these inputs, the recalculated CO2 Flowrate is 1.54 LPM.

With these revised parameters, the recipe is updated and transferred to the PLC, FIG. 7. This adjustment cycle can be iteratively applied until the error associated with the dependent variable is diminished and meets satisfaction. In this illustration, the error shrank from 0.3% to a mere 0.03% in a single iteration.

The principle behind this strategy is feedback correction. By understanding how far off the system was on the initial try (the error), it can adjust its calculations to better meet the desired outcomes on subsequent attempts. Adding the error to the original input effectively nudges the calculations in the right direction. This iterative approach of prediction, observation, and correction allows the system to focus on the true values needed to meet the desired outcomes, even when faced with unpredictable real-world factors.

In essence, by using the error to adjust input values, the system is constantly fine-tuning its predictions to better match actual outcomes, ensuring optimal results.

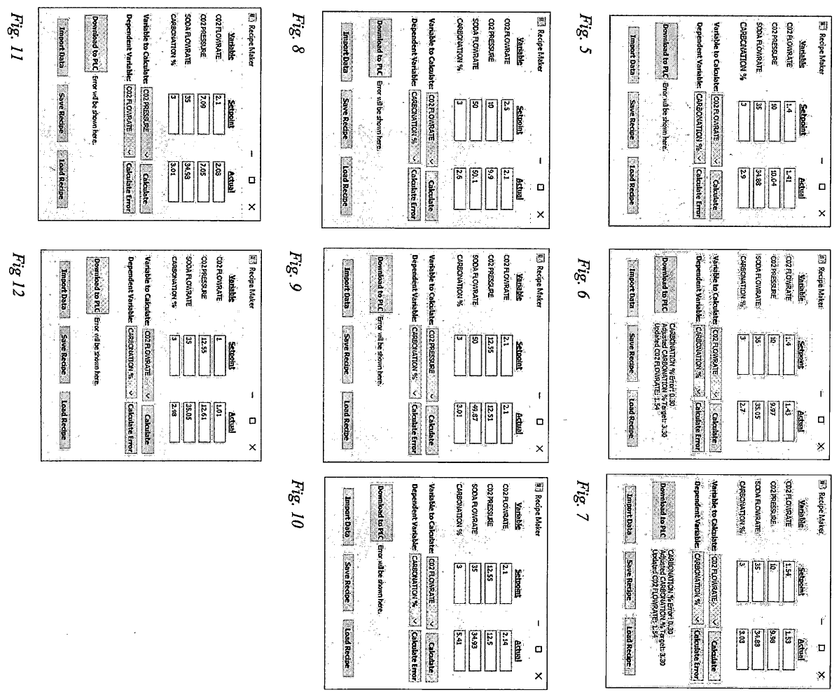

Occasionally, as recipes are tuned, operators might encounter process constraints related to specific variables. For instance, with the Soda flow rate elevated to 50 LPM, the Recipe Maker calculates the CO2 flowrate to be 2.5 LPM. However, constraints limit the CO2 supply to only 2.1 LPM, as seen in FIG. 8.

As a workaround, the operator sets the CO2 flowrate to its upper limit of 2.1 LPM. Subsequently, the Recipe Maker is employed to compute the necessary CO2 Pressure to achieve the desired results. The CO2 Pressure is reselected as the “Variable to Calculate”, resulting in a recalculated value of 12.55 PSI. This refreshed recipe is then downloaded to the PLC, and after reaching a steady state all variables have reached within an acceptable range of the given setpoints, FIG. 9.

To further demonstrate the flexibility of the Recipe Maker while controlling the process variables, here is an example where the Soda Flowrate has now been reduced to 35 LPM. With the current C02 Pressure and Flowrate settings, the carbonation level is 5.41%, way above the setpoint of 3%, FIG. 10. To bring the carbonation level down, the C02 Flowrate or C02 Pressure must be reduced. The user can choose either as the Variable to Calculate.

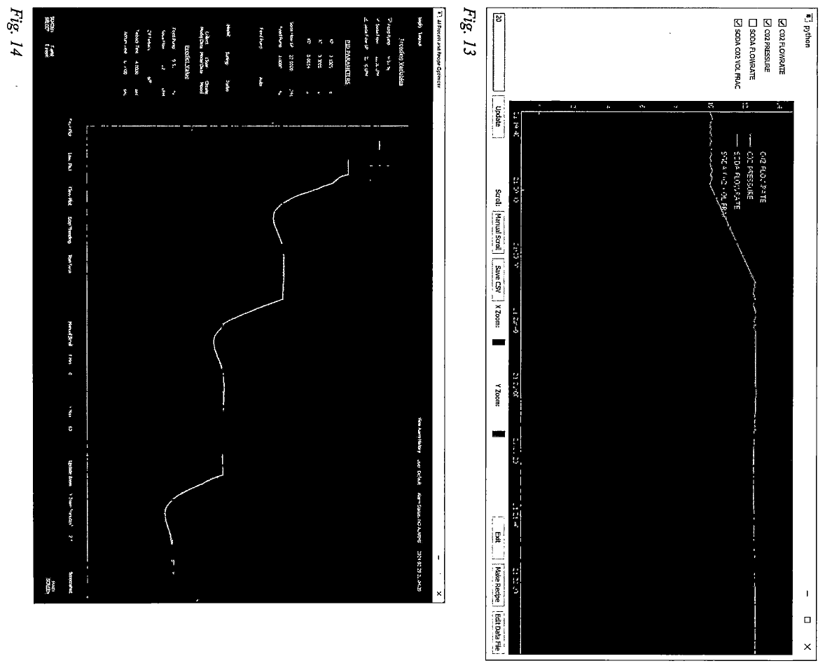

The user has first selected the C02 Pressure for the Recipe Maker to calculate, FIG. 11. The Recipe Maker has recalculated the C02 Pressure to be 7.08 PSI. Updating the recipe and downloading the new values to the PLC, the carbonation level is now 3.01%, right at the setpoint.

The C02 Flowrate could have also been selected as the variable to calculate, FIG. 12. By selecting the C02 flowrate, the Recipe Maker has calculated the C02 Flowrate to be 1 lpm. Updating the recipe and downloading the new values to the PLC, the Carbonation level is now 2.98%, right at the setpoint.

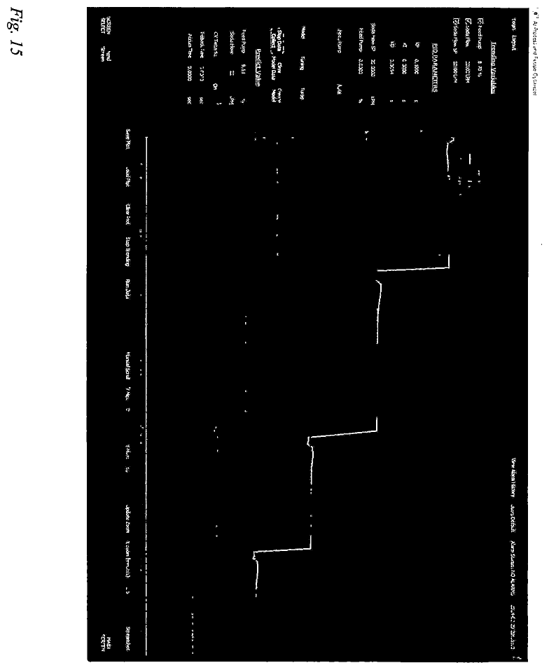

As recipes are tweaked, the live values can be viewed and monitored on a trending screen as seen in FIG. 13. Visual aids play a pivotal role in enhancing the operator's experience and understanding while using the Recipe Maker software. By presenting data trends through intuitive graphical representations, as shown in FIG. 13, operators can quickly grasp the state of different parameters over time. This immediate visualization provides a clear snapshot of real-time system performance and also helps in early identification of anomalies or deviations from the expected behavior, queing the operator. Operators can take proactive measures, making informed decisions based on visual feedback rather than sifting through raw numerical data to adjust the recipes.

In the middle of a Process run, there is the capability to dynamically enhance the accuracy and efficiency of models with the “Import Data” feature. By utilizing the “Import Data” button, new datasets can be integrated into the existing model infrastructure. The Import Data feature can also be initiated automatically on a timed basis, for example importing the live data and updating the variables' models every 2 minutes.

It's commonly understood in data science that models thrive on information. Every new piece of data can provide fresh insights, potentially refining the model's understanding of intricate patterns and relationships. By regularly updating the models with fresh batches of data, one can ensure that they are operating at their optimal capability.

By routinely importing new data, recipe makers are enhancing the predictive accuracy of their models. With every new data import, the assurance that the model's predictions are in line with the most recent trends and patterns grows stronger.

Although the provided example focuses on soda carbonation, this software tool is versatile, finding relevance in various industries such as chemical manufacturing, pharmaceuticals, food processing, and energy production. Historically, these sectors depended on separate offline systems to create and modify process recipes. These systems often lagged in data synchronization, leading to inefficiencies in real-time operations. There is a pronounced need in the industry for a tool that could interface in real-time that could not only gather and analyze live data but also develop Process Recipes, detect errors promptly, make immediate corrections, and continuously update its models based on the latest process trends.

The software also innovates on traditional PID loop control by integrating trend data analysis and predictive modeling to refine PID loop responses. Similar to the recipe maker, the software first trends data at the lower to upper end of the process variable's (PV) and the control variable's (CV) range in the PID loop. When a recipe is altered, leading to a change in the PV setpoint, the predictive model is used to calculate a new CV output. This preemptive adjustment provides a more accurate starting point for the CV, enabling the control system to reach the new setpoint more efficiently than traditional methods.

For example, in a scenario where the CV is a feed pump and the PV is the soda flow rate, adjustments to the PV's setpoint trigger the predictive model to adjust the pump's output. This adjustment aims to match the new flow rate requirement immediately, thereby reducing the time and oscillation typically associated with PID loop adjustments to achieve stability. Comparative trend analyses, illustrated in FIGS. 14 and 15, highlight the performance benefits of this “AI Enhanced” PID loop approach over standard PID loop controls.

After each process run the software systematically compares newly collected process data and equipment performance metrics against predicted models established from historical process runs. This comparison is automatically performed following each recipe execution and its parameters adjustment. Such analyses facilitate early detection of deviations or irregularities in process outcomes and equipment function.

For instance, should a specific recipe parameter combination historically result in a particular dependent variable outcome (e.g., a certain level of carbonation in a beverage production process), but a recent run yields a significantly different result, this deviation is flagged for further investigation. This proactive approach enables operators to conduct targeted checks on equipment calibration and functionality, potentially averting larger operational issues.

Additionally, the performance of each CV in the PID loops is scrutinized. If a component such as a pump or control valve deviates from its expected operational range predicted by the model (e.g., requiring higher output to achieve a setpoint), this variance is flagged for maintenance review. Such analytics support preemptive maintenance strategies, contributing to overall operational reliability and efficiency.

1. A software tool for real-time industrial or laboratory process management interfaces with a PLC, collects and trends data, uses advanced algorithms to craft Process Recipes from historical data, and features a Recipe Maker module that employs regression, machine learning, and/or vector analysis to develop models, determine variable relationships, and adjust setpoints based on a user selectable ‘variable to calculate’ for targeted outcomes.

2. The software tool from claim 1 also has an error-checking mechanism comparing intended outcomes with actual results and uses an error adjustment method on a designated dependent variable, adjusting input values based on discrepancies to compute related variables accurately.

3. A methodology within the software tool's recipe maker from claim 1 that updates existing models with fresh datasets, enhancing predictions based on recent trends and patterns.

4. A method for enhancing Proportional-Integral-Derivative (PID) loop performance through predictive modeling, which involves predicting a Control Variable (CV) output to achieve a new Process Variable (PV) setpoint upon adjustment. This method applies the predicted CV output to reach the PV setpoint more efficiently than conventional PID loop adjustments and uses the prediction as an advanced baseline for immediate control response, thus improving the speed and accuracy of achieving desired PV setpoints.

5. A method for evaluating and enhancing process and equipment performance post-process run by analyzing the outcomes of each recipe's dependent variable and each CV's performance within PID loops against expected values from predictive models. This method identifies discrepancies to flag potential abnormal equipment or process performance and employs the analysis for preventative maintenance and operational adjustments, preventing minor issues from escalating into significant disruptions.
